(19) United States
(12) Patent Application Publication
(10) Pub. No.: US 2008/0195554 A1
(43) Pub. Date: Aug. 14, 2008

(54) Tool to find deductions from HUD settlement statement that can be used by a stand alone system or be used with a Real Estate Web Platform

(76) Inventors: Narinder Pal Sandhu, Fremont, CA (US); Pankat Ashwin Shukia, Fremont, CA (US)

Correspondence Address: FURR LAW FIRM, 2622 DEBOLT ROAD, UTICA, OH, 43080, US

(21) Appl. No.: 11/674,141

(22) Filed: Feb. 12, 2007

(51) Int. Cl. G06Q 40/00

(52) U.S. Cl. 705/36 R

(57) ABSTRACT

The current invention is a tool to find HUD settlement statement deductions that can be used by a stand alone T-sap or be used with a Real Estate Web Platform to provide intelligent guidance to investors to maximize their returns and assist in the finding of deductions for a Section 1031 exchange, Depreciation Schedule, Sale or Purchase of Property tax filing tiny simple application for a real estate web application platform that will serve the needs of Real Estate investors in a unique way. The platform supports web applications that have inbuilt intelligence to guide an investor when dealing with accelerated deprecation issues. Each application operates independently or in combination to meet customer needs and automatically recommends other web applications in accord with customer needs. The platform will enable interaction via multiple devices not limited to keyboard, fax, voice, PDA, and cell phones.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a method of assisting real estate investors in their investments to maximize their returns, more particularly a system that assists with HUD statement sheet deductions and assist in the finding of deductions for a Section 1031 exchange tax filing in a T-sap for like kind exchanges and other T-saps that use data from a HUD statement. Some other examples of T-saps that use HUD statement are Depreciation Schedules, Sale or Purchase of a residential rental property.

The present invention is a tool to find HUD settlement statement deductions that can be a stand alone T-sap or be used with a Real Estate Web Platform used to provide intelligent guidance to investors to maximize their returns and assist in the finding of deductions for a Section 1031 exchange tax filing, Depreciation Schedules, Sale or Purchase of a residential rental property.

The T-sap for 1031 exchange will find all expenses based on using the HUD statement and intelligently allocates the expense item by using the line numbers of the HUD statement. The T-sap for 1031 exchange will create a simple easy to understand report and visual display of complex financial concepts of a 1031 transaction.

The T-saps for Depreciation Schedule, Sale or Purchase of residential rental property will find all expenses based on using the HUD statement and intelligently allocate the expense item by using the line numbers of the HUD statement.

The platform supports web applications that have inbuilt intelligence to guide an investor. Each T-sap operates independently or in combination to meet customer needs and automatically recommends other T-saps in accord with customer needs. The platform will enable different modes of input devices for interaction such as keyboard, touch-screen, fax, audio, cellphones, pda, etc. and will output information on appropriate displays such as video terminals, e-mail, fax, audio, cellphones etc. (page has a great description of output devices. The platform will also enable collaboration for those who seek assistance through technology.

2. Background

With the world moving at a faster and faster pace and with all the changes with technology and Internet, a real estate investor needs every tool that they can have available. But every investor is different and needs a different set of tools and options that an investor can optimize for their own use especially when dealing with HUD statement, which has line items that can be used to identify expenses that a real estate investor needs to state in order to maximize ROI on their Tax return.

Currently in the market there are products that aggregate the pain points of Real Estate investors to use a monolithic application which are mostly desktop applications. Therefore critical pain points are not served.

There exists a need for a web tool that will store their applicable information and will allow them to add other web tools when necessary with the data being leveraged from the current web tools to new web tools that investor starts using and providing a seamless experience between current web tool and new web tool that investor is using. These web tools are called T-saps (Tiny Simple Applications).

3. Prior Art

U.S. Pat. No. 7,076,452 by Florance, et al. and issued on Jul. 11, 2006, is for a System and method for collection, distribution, and use of information in connection with commercial real estate.

U.S. Patent Application No. 20030126052 by Rademaekers, et al. and published on Jul. 3, 2003, is for a Method and apparatus for establishing real estate investments. It discloses a system, method, apparatus, computer program code and means for establishing a real estate investment which include receiving information identifying a user responsible for a new real estate investment, receiving information identifying the new real estate investment, monitoring the received information identifying the new real estate investment for information triggering a trigger event, and causing the transmission, when the triggering event is detected, of a notification message to a designated recipient.

U.S. Patent Application 20020046159 by Raveis and published on Apr. 18, 2002, is for a System and method for managing transactions relating to real estate. It discloses a system and method for managing real estate transactions. The method includes the steps of receiving and storing data relating to a plurality of contacts including buyers and sellers of real estate, receiving and storing data relating to a plurality of vendors each associated with at least one phase of a real estate transaction, accessing vendor data based upon occurrence of a particular phase of the real estate transaction and communicating data relating to the vendors to a contact upon occurrence of the particular phase of the real estate transaction.

United States Patent Application 20020010674 by Kent and published on Jan. 24, 2002, is for a Method of providing tax credits and property rental and purchase.

There exists a need to get better results. There is still room for improvement in the art.

### SUMMARY OF THE INVENTION

The current invention is a tool to use HUD settlement statement to find deductions that can be used by a stand alone T-sap (Tiny Simple Applications) or be used with a Real Estate Web Platform. The stand-alone T-sap or the Real Estate Web Platform use the HUD settlement statement which has expense items that can be written off.

The 1031 exchange process has a lot of complex financial concepts. The T-sap for 1031 exchange will find all expenses that should be accounted for via the HUD statement, visually and simply explain the complex financial concepts of a 1031 exchange. The other T-saps like Depreciation Schedule, Sale or Purchase of residential property intelligently allocate the expenses to minimize the taxable gain.

The platform supports web applications that have inbuilt intelligence to guide an investor when dealing with real estate deduction issues. Each T-sap operates independently or in combination to meet customer needs and automatically recommends other T-saps in accord with customer needs. The platform will enable interaction via multiple devices not limited to keyboard, fax, voice, PDA, and cell phones. The platform will also enable collaboration for those who seek assistance through technology.

A Real Estate Investors critical pain points are better served specifically in a disaggregated manner through the Tiny Simple Applications. As the user wants to solve multiple pain points, the experience will be seamless as the systems will have multiple Tiny Simple Applications that have common data storage and common application model.

### GLOSSARY OF TERMS

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a User accesses the system;

FIG. 2 shows the system on a User's computer;

FIG. 3 displays the central processing system and the Tiny Simple Applications;

FIG. 4 displays the HUD Statement system screen:

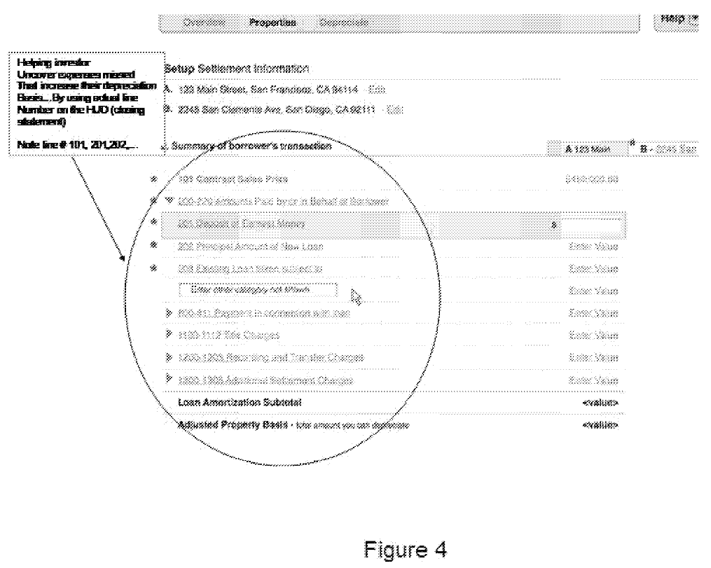

FIG. 5 displays gain for a sold property using a Section 1031 Exchange:

FIG. 6 displays the total gain on two properties;

FIG. 7 displays the Realized Gain;

FIG. 8 displays the Mortgage Boot:

FIG. 9 displays deferred Gain and New Basis;

FIG. 10 display a screen shot of the Systems 1031 Defer Screen; and

FIG. 11 displays s screen shot of the Closing Information for a Sold Property.

### BRIEF DESCRIPTION OF THE PREFERRED EMBODIMENTS

There are a number of significant design features and improvements incorporated within the invention. The current invention is an HUD Statement Deduction and assist in the finding of deductions for a Section 1031 exchange tax filing system (and other T-saps) that can be a stand alone system or a tiny simple application for the real estate web application platform.

The present invention relates to system 1 and a destination web platform 100 that will serve the needs of Real Estate investors in a unique way. The system 1 can be a stand alone system or one that will create and have Tiny Simple Applications (T-saps) that serve unique functions that solve the pain points of real estate investors.

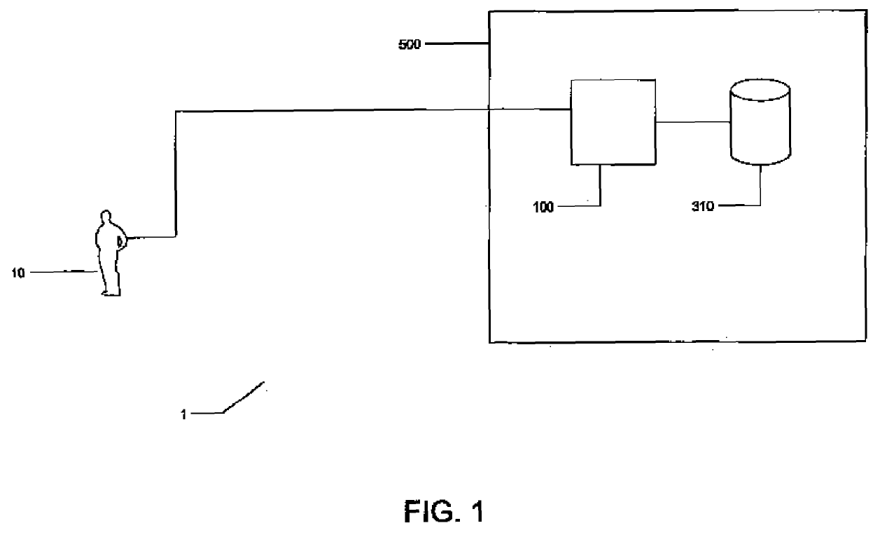

FIG. 1 illustrates a functional diagram of a computer network for World Wide Web 500 access to the System 1 from a plurality of Users 10 who accesses the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon. Each user 10 will have a display device such as a monitor and an input device like a keyboard. This display and input device can even be a PDA like a blackberry.

The Users 10 contact the System Web Site 100 using an informational processing system (Client) capable of running an HTML compliant Web browser such as Microsoft's Internet Explorer, Netscape Navigator, Lynx, Safari, and Mosaic. A typical system that is used is a personal computer with an operating system such as Windows 95, 98 or ME, NT, 2000, Maclntosh, or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims. The User 10 can also access the system 1 through voice and E-mail, as well as any other standard or new form of communication.

In one preferred embodiment of the invention, the Users 10 connect to the System 1. The User 10 will typically be a real estate investor. The system 1 will have a database 310 for the storing of data and code.

The system 1 will enable different modes of input devices for interaction such as keyboard, touch-screen, fax, audio, cellphones, pda, etc. and will output information on appropriate displays such as video terminals, e-mail, fax, audio, cellphones etc.

Output can include a screen, a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing system 1 for both embodiments includes computer processing means for processing data, storage means for storing data on a storage medium, and communication means for transferring data in a secure environment.

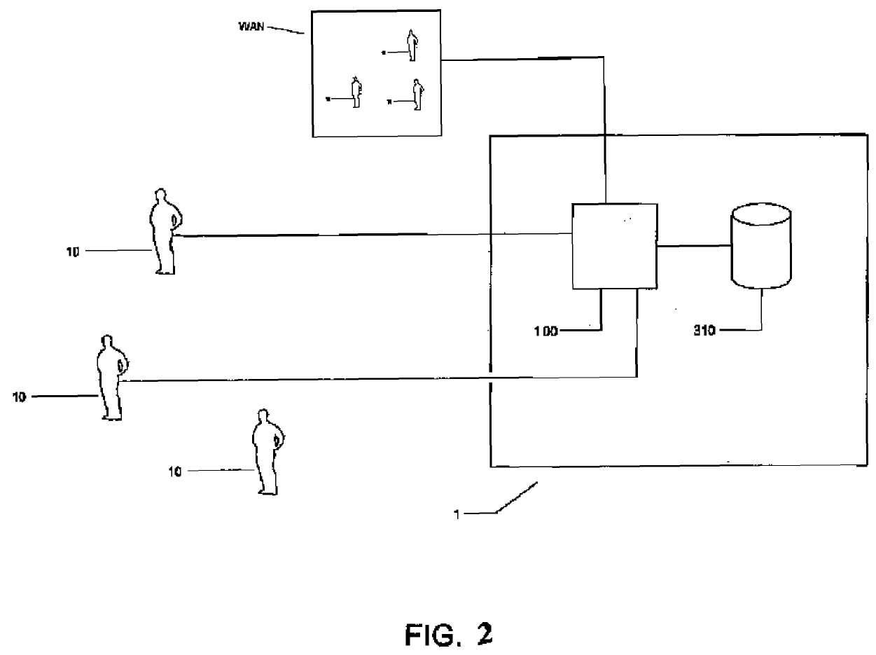

In another embodiment, the system 1 can be a stand alone system used by the user 10 loaded on the user's computer or server without the need to connect to the system 1 through the Internet. This embodiment can be connected to multiple Users 10 through a WAN connection as shown in FIG. 2.

The user 10 will log on to the system 1 using a username and password using generally accepted username and password rules. This username and password will be unique to the user 10.

The system 1 can be a stand alone system but in the preferred embodiment it will be a tiny simple application run on a platform.

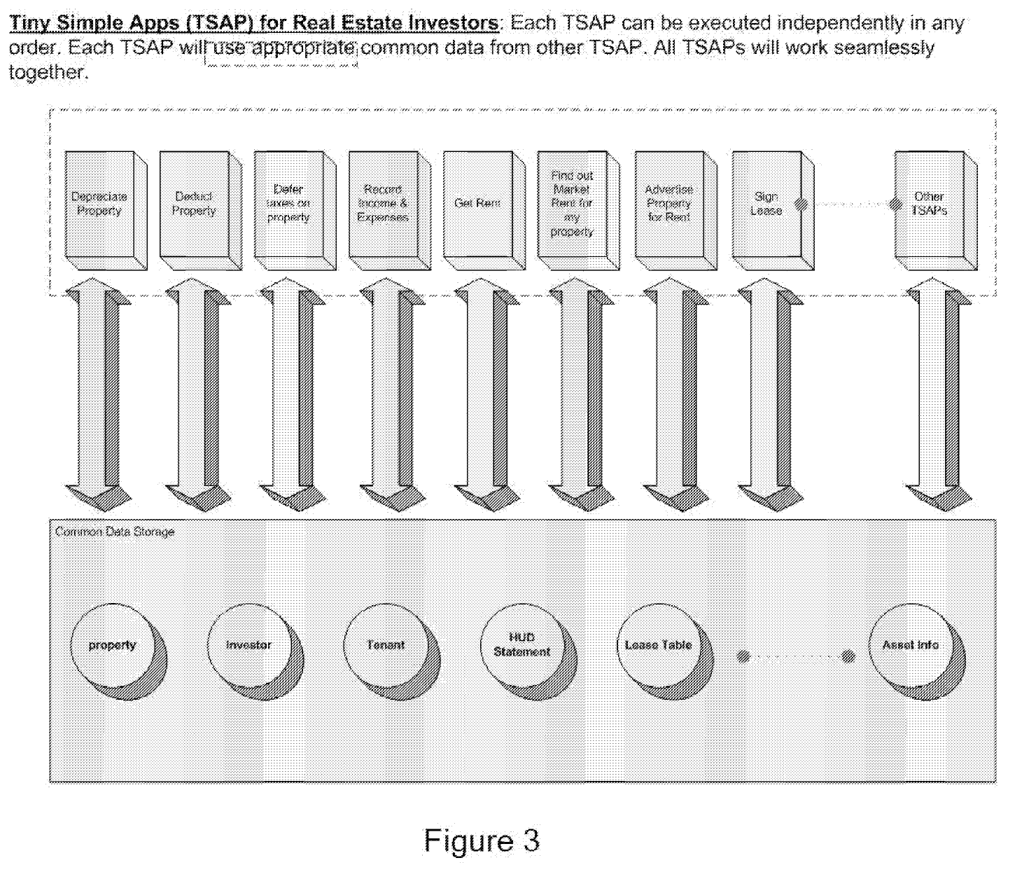

The system 1 is a central processing application 200 which will run system architecture, background and maintenance functions such as database 310 management, logon procedure, security functions and data input and output. The central processing application 20 will manage the running of the Tiny Simple Applications 210 in the platform as shown in FIG. 3.

The central processing application 200 automatically analyzes the data entered by a real estate investor and guides the investor to select the Tiny Simple Applications 210 that enable the real estate investor to maximize their return on investment.

The central processing application 200 creates a simple, seamless, and integrated experience with multiple Tiny Simple Applications 210. The central processing application 200 is selected intelligently based on the needs of the investor.

A Real Estate Investor's critical pain points are better served specifically in a disaggregated manner through the Tiny Simple Applications 210. As the user wants to solve multiple pain points, the experience will be seamless as the systems will have multiple Tiny Simple Applications that have common data storage 310 and central processing application 200.

A Tiny Simple Application 210 is an application that solves one need of a Real Estate Investor. An Example of a Tiny Simple Application 210 is an application that assists a Real Estate Investor with filling out the deductible expenses on their income tax schedule E for property. A Tiny Simple Application 210 is designed to be simple and small. It solves one problem. It solves the situation and problem that is put in front of it for this functionality. It has inbuilt intelligence that guides investors to maximize their return. It will access the database 310 for all required information dealing with the problem being solved. It will also allow for the inputting of data needed for the solution of the problem and pass that data on to the central processing application 200 for storage to the database 310.

A Tiny Simple Application 210 can be executed in any order with other Tiny Simple Applications 210. It could be the only Tiny Simple Application executed or it could be one of many (in any sequence first, middle or last). It will give the user some suggestions on what to do next based on its context and findings.

The current invention is for a HUD Statement Tiny Simple Application 610 that will assist an investor with allowable deductions. This is a Tax Saving web tool for a Real Estate investor. The HUD Statement Deduction will identify all deductions using the line numbers of a HUD statement, this will be used by all Tiny Simple Application (including 1031 exchange T-sap, Depreciation Schedule T-sap, Sale or Purchase of residential rental property T-saps.) 610 allows for HUD Statement Deductions in a Real Estate investment.

In the preferred Embodiment, the HUD Statement Deduction Tiny Simple Application 610 will provide data and receive data from some of the other Tiny Simple Applications 210 such as a Tenant Screener Application 220, which is a tool to help investors advertise, manage the flow of tenant applicants, evaluate potential tenant applicants, automated credit and other worthiness checks on potential tenants, and automated electronic leasing technology; a property performance manager 225, which is a bookkeeping solution specifically for the real estate investor; a Payment processor application 230, which is an automated electronic system for rent payment from tenant to landlord, payment to service providers; a properties listed application 235; a properties available application 240; and a Community application 245, which is a an online forum for the investors and associated specialist (Realtor, loan brokers, property managers, etc.) to dialogue and learn from each other. The system 1 will have other Tiny Simple Applications to solve other issues as well and will allow the development of new Tiny Simple Applications to address a Real Estate Investor's future and current issues and pain point. The system 1 will create a repository of properties for sale and acquisition and provide tools to help each investor make the right buy/sell decisions for their situation.

The system 1 including the central processing application and the tiny simple application can be written in any computer language that can perform the functions required. Each of the applications can be written in its own language so long as the applications can communicate and transfer data to each other properly. This adds to the flexibility of the system.

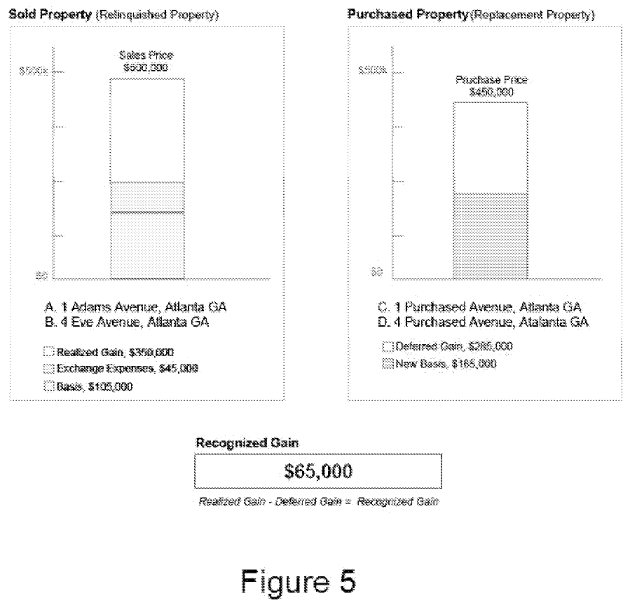

Table 1 shows a sample HUD statement sheet. The values are filled in and summed. The US Department of Housing and Urban Development tracks home transactions by way of HUD settlement statements. HUD Settlement Statements are provided to the new owner of a property at the closing meeting FIG. 5 displays the information being entered into the system's HUD statement screen.

The system 1 will have the user 10 input the values of the HUD Statement sheet into the screen. The system 1 will then use this information and information about allowable deductions and tax law that have been programmed into the system 1 to come up with and list all of the deductions that the buyer and seller can deduct on their taxes. The system 1 will have an editing function that will allow a user to make corrections and changes to the data.

In another embodiment, the system 1 will scan a HUD Statement in an optical ready to populate the fields for the system 1.

In the preferred embodiment the data will be entered electronically through a database of data on the sale. The system 1 will also be used to print out the HUD Settlement sheet. The system 1 will be used in capturing all expenses from the HUD statement to minimize taxable gain.

The system will use data input or from database or from the common platform when used as a HUD Statement Tiny Simple Application 610.

The system 1 will also use the data to calculate the values and deductions for a 1031 Exchange. A 1031 Exchange which is known as a Like Kind Exchange is a transaction under the United States Tax Laws where an asset such as real estate ike land or a building, is sold and the proceeds of the sale are then placed in an asset of a similar like kind asset, then no capital gain or loss is recognized, allowing the deferment of capital gains taxes that would have been due on the first sale. This law is defined under section 1031 of the Internal Revenue Code, 26 U.S.C. §1031.

There are a number of IRS rules that control Section 1031 Like Kind Exchanges. There are limit on the the length of time that the replacement property must be held before it may either be sold or used to enter into a new tax deferred exchanged. The system 1 will be programmed with the latest rules covering Section 1031 and will use this information when providing information and direction to the user 10.

For example, FIG. 5 displays a transaction using Section 1031 like kind exchange. The Sold property has a sell price of $500,000 with a net realized gain of $350,000 and exchange expense of $45,000 and a basis of $105,000. The purchased property is $450,000 which gives a deferred gain of $285,000 and a new basis or $165,000. This gives a recognized gain of $65,000 which is the realized gain mius the deferred gain.

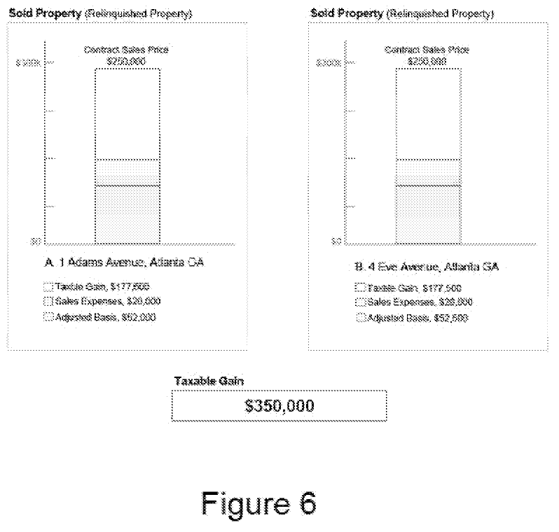

FIG. 6 shows the total gain on transaction without a Section 1031 exchange. One property sells for $250,000 with a basis of $52,000 and a sales expense of $20,000 with a taxable gain of $177,500 and the second property sells for $250,000 with a basis of $52,500 and sales expense of $20,000 with a taxable gain of $177,500 for a total taxable gain of $350,000.

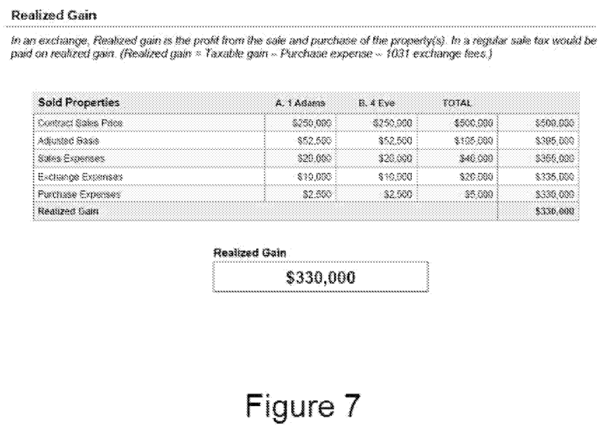

FIG. 7 displays an example of realized gain. In a like kind exchange, realized gain is the profit forms the sale and purchase of the property(s). In a regular sale tax would paid on realized gain.

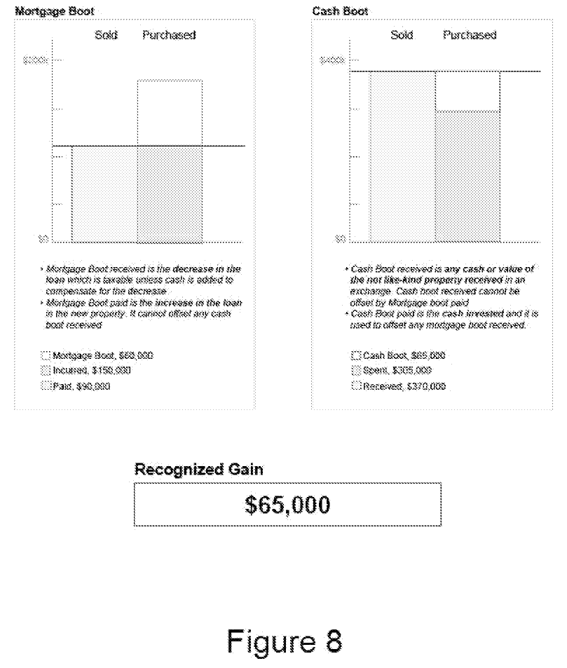

FIG. 8 displays an example of mortgage boot and cash boot. Mortgage boot in a 1031 exchange is received is the decrease in the loan which is taxable unless cash is added to compensate for the decrease. Mortgage boot paid is the increase in the loan in the new property. It cannot offset any cash boot received. Cash Boot received is any cash or value of the not like-kind property received in a like kind exchange. Cash boot received cannot be offset by Mortgage boot paid. Cash Boot paid is the cash invested and it is used to offset any mortgage boot received.

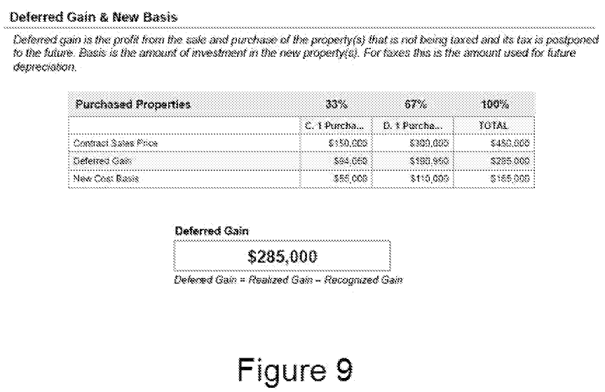

FIG. 9 displays and example of deferred gain and new basis. Deferred gain is the profit from the sale and purchase of the property(s) that is not being taxed and its tax is postponed to the future. Basis is the amount of investment in the new property(s). For taxes this is the amount used for future depreciation.

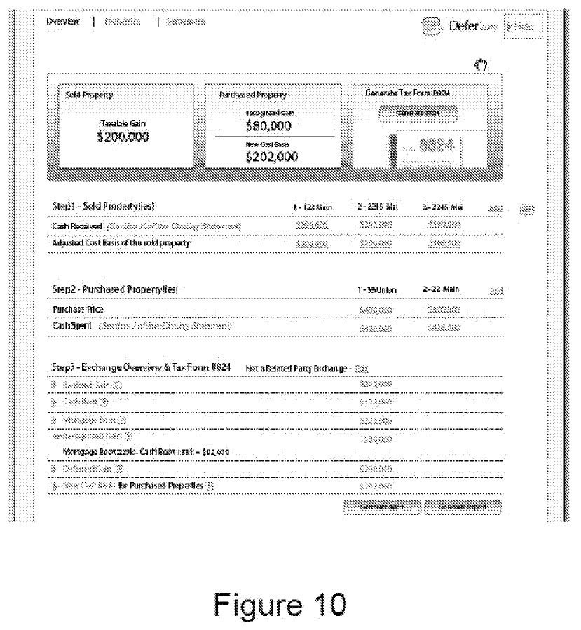

FIG. 10 displays a screen shot of the Systems 1031 Defer Screen. It is visual graphic display of complex concepts related to 1031 exchange based on the information provided. It is set up as an easy to read and understand overview of the difficult concepts and calculations of the 1031 like kind exchange.

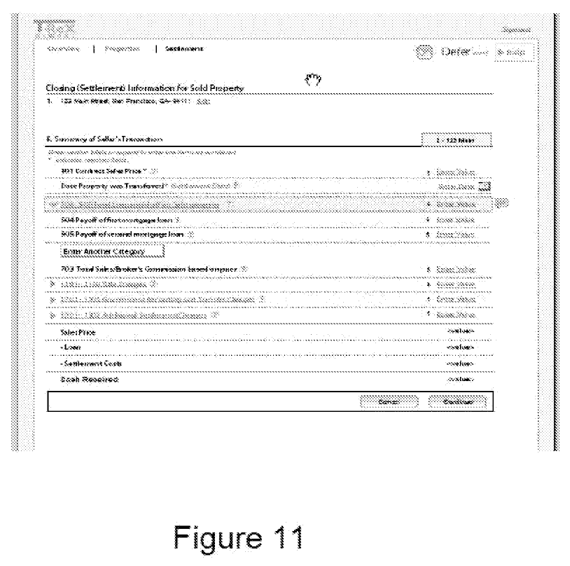

FIG. 11 displays screen shot of the Closing Information for a Sold Property. It displays one of the system's screens that shows using settlement information to Capture expenses.

### Advantages

The system is designed to provide tools to help manage investment property and maximize their returns. It is designed to create a destination for small real estate investors to learn from each other. It will create repository of properties for sale and acquisition appropriate to small real estate investor, with tools to help each investor make right buy/sell decisions for their situation.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A real estate investor system comprising: processing the data on a HUD statement, reviewing the data from the HUD statement and proving deductions.

2. A system according to claim 1 where the system will load the data for the HUD statement from a database.

3. A system according to claim 1 where the user will load the data for the HUD statement using an input device.

4. A system according to claim 1 where the system will use an optical reader to load the data.

5. A system according to claim 1 where the system will print out the HUD statement.

6. A system according to claim 1 where the system will allow the editing of the data.

7. A real estate investor system comprising: processing the data from a real estate transaction for a plurality of properties and proving the proper figure for a real kind tax property exchange.

8. The system according to claim 7 wherein said results are provided in a graphic format.

9. The system according to claim 1 wherein said system provides a summary of said transaction.

10. A real estate investor system comprising: the tiny simple application processing the data on a HUD statement, reviewing the data from the HUD statement and proving deductions communicating with a central processing application and having a plurality of other tiny simple applications that communicate with the central processing application.

11. A system according to claim 10 where the system will load the data for the HUD statement from a database.

12. A system according to claim 10 where the user will load the data for the HUD statement using an input device.

13. A system according to claim 10 where the system will use an optical reader to load the data.

14. A system according to claim 10 where the system will print out the HUD statement.

15. A system according to claim 10 where the system will allow the editing of the data.

16. A system according to claim 10 where said system will process the data from a real estate transaction for a plurality of properties and proving the proper figure for a real kind tax property exchange.

17. The system according to claim 10 wherein said central processing application is connected to a database.

18. The system according to claim 10 where each of said tiny simple applications will be able to use data collected by other tiny simple applications that have been execute prior to its execution.

19. The system according to claim 10 where said system also collaboration between real estate investors.

20. The system according to claim 10 where a plurality of tiny simple applications can be executed independently and can be executed any order.
